(19) United States
(12) Patent Application Publication
(10) Pub. No.: US 2007/0071081 A1
(43) Pub. Date: Mar. 29, 2007

(54) Communication analysis apparatus and method and storage medium storing communication analysis program, and organization rigidification analysis apparatus and method and storage medium storing organization rigidification analysis program

(75) Inventors: Keeichi Nemoto, Kanagawa (JP); Masakazu Fujimoto, Kanagawa (JP); Nobuhiro Yamasaki, Kanagawa (JP); Noriyuki Kurabayashi, Kanagawa (JP); Yuichi Ueno, Kanagawa (JP); Masamichi Takahashi, Kanagawa (JP); Atsushi Ito, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/353,094

(22) Filed: Feb. 14, 2006

(30) Foreign Application Priority Data
Sep. 29, 2005 (JP) 2005-284839

(51) Int. Cl. H04B 17/00

(52) U.S. Cl. 375/224

(57) ABSTRACT

A communication analysis apparatus includes: first decision means for deciding a chance of a communication between users; second decision means for deciding an occurrences of the communication between the users; and analysis means for analyzing the occurrences of the communications decided by the second decision means, in association with the communicational chances decided by the first decision means.

### BACKGROUND OF THE INVENTION

(i) Field of the invention

This invention relates to technology for analyzing communications, and more particularly to technology which is most suited to analytically reveal the rigidification of an organization, etc. through the analysis of communications.

(ii) Description of the Related Art

In case of a research project or development project, a relationship in which, when the amount of intra-organizational communications decreases in spite of increase in extra-organizational communications, the performance of the project of a technical service lowers, is stated as “Not Invented Here (NIH) Syndrome” in R&D Management, 1982, 12, pp. 7-19, by Ralph Katz and Thomas J. Allen. There is the relationship that the performance of the project is high from 1.5 till 4.9 in terms of the number of elapsed years of the project, and that the decrease of a communicational frequency is thereafter correlative to the lowering of the performance. Accordingly, the performance or rigidification of an organization can be decided by analyzing the communications.

Meanwhile, in case of measuring the communicational amount of each user, inevitabilities or accidentalities at which communications can occur must be considered in addition to the mere amount of the communications. That is, there must be considered how many communicational chances the user had, and to what degree he/she could utilize the communicational chances. It is accordingly desired to precisely evaluate the communications in consideration of the inevitabilities or accidentalities thereof.

Incidentally, techniques in each of which a personal network is built from the viewpoint of organizational communications in the actual world have been thought out as proposals concerning this invention More specifically, Patent Document 1 has proposed a new information processing technique wherein human relations built by card exchanges can be utilized from the viewpoint of business power. Patent Document 2 has proposed a technique wherein the history of the communications between each individual and others is managed as personal chain information, and the personal chain information of the individual is shared and is effectively utilized. Neither of the related-art proposals, however, decides the performance or rigidification of an organization by precisely grasping the communications.

Patent Document 1: JP-A-2003-16235

Patent Document 2: Japanese Patent No. 3,446,886

### SUMMARY OF THE INVENTION

This invention has been made by considering the above circumstances.

The present invention provides, as an illustrative, non-limiting embodiment, a communication analysis apparatus including: first decision means for deciding a chance of a communication between users; second decision means for deciding an occurrence of the communication between the users; and analysis means for analyzing the occurrences of the communications decided by the second decision means, in association with the communicational chances decided by the first decision means.

Accordingly, one of advantages of this invention is to provide a technique in which communications are analyzed from both the communicational chances and communicational amount of each user.

Another advantage of this invention is to provide a technique which is well suited to analyze changes in the utilization state of the communicational chances in an organization.

Yet another advantage of this invention is to provide a technique which can analytically reveal the rigidification, etc. of the organization from the lowering of the utilization state, etc.

Those and other advantages of this invention will be discussed in detail with reference to illustrative, non-limiting embodiments described hereinafter.

### BRIEF DESCRIPTION OF THE DRAWINGS

The embodiments of the present invention will be described in detail based on the following figures, wherein:

FIG. 1 is a diagram for explaining the relationship between the chances of communications and the occurrences of the communications in relation to this invention;

FIG. 2 is a diagram for explaining the configuration of Embodiment 1 of this invention;

FIG. 3 is a diagram for explaining an action log in the above embodiment 1;

FIG. 4 is a diagram for explaining an operating example of the above embodiment 1;

FIG. 5 is a diagram for explaining another operating example of the above embodiment 1;

FIG. 6 is a diagram for explaining an analytical result display example in the above embodiment 1;

FIG. 7 is a diagram for explaining another analytical result display example in the above embodiment 1;

FIG. 8 is a diagram for explaining the configuration of Embodiment 2 of this invention;

FIG. 9 is a diagram for explaining an operating example of the above embodiment 2;

FIG. 10 is a diagram for explaining an analytical result display example in the above embodiment 2;

FIG. 11 is a diagram for explaining another analytical result display example in the above embodiment 2;

FIG. 12 is a diagram for explaining another analytical result display example in the above embodiment 2;

FIG. 13 is a diagram for explaining another analytical result display example in the above embodiment 2;

FIG. 14 is a diagram for explaining still another analytical result display example in the above embodiment 2;

FIG. 15 is a diagram for explaining the configuration of Embodiment 3 of this invention;

FIG. 16 is a diagram for explaining a modified embodiment to the above embodiment 1.

### DETAILED DESCRIPTION OF THE INVENTION

In an example of the fundamental configuration of this invention, communications are analyzed from both the communicational chances and communicational amount of each user by using the action logs of the user in an organization where a plurality of users exist, thereby to analyze changes in the utilization state of the communicational chances in the organization and to analytically reveal the rigidification, etc. of the organization from the lowering of the utilization state, etc. More specifically, the sharings of places (chance encounters) for very short time periods can be considered as the communicational chances, namely, the plausibilities of the occurrences of communications for the reason that the users approached physically though no dialogs occurred. Therefore, the amount of communications is more accurately measured by considering the plausibilities at which the communications can occur, for the communicational amount, thereby to measure the rigidification of the communications of the organization.

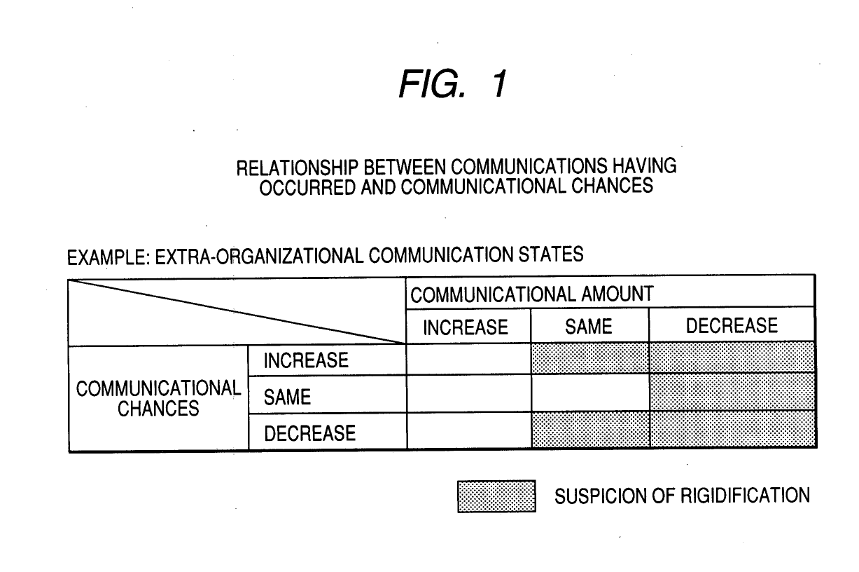

FIG. 1 shows the relationship between the occurrences of communications (approaches for, at least, a predetermined duration) and the chances of the communications (all approaches), concerning the communications outside an organization. In a case where the communications do not increase in spite of increase in the chances of the communications, it can be decided that the rigidification of the organization is highly possible. Also in a case where the communications have decreased without any change in the communicational chances, the possibility of the rigidification is high. Besides, when the amount of the communications does not change or decreases in case of decrease in the chances of the communications, the possibility of the rigidification is similarly high.

This invention will be further described incidentally, reference numerals in an embodiment will be conjointly indicated here in order to facilitate understanding, but it is a matter of course that the indications are not intended to limit the technical scope of this invention.

According to one aspect of this invention, a communication analysis apparatus is provided with first decision means (a communicational chance decision portion 51) for deciding a chance of a communication between users; second decision means (a communication occurrence decision portion 52) for deciding an occurrence of the communication between the users; and analysis means (a communication analysis portion 53) for analyzing the ounces of the communications decided by the second decision means, in association with the communicational chances decided by the first decision means.

In the configuration, changes in the utilization state of the communicational chances in an organization are analyzed, whereby the rigidification, etc. of the organization can be analytically revealed from the lowering, etc. of the utilization state.

The communication maybe performed facing each other or through a telephone or the like in a physical space, or it may well be one in an electronic space (for example, electronic chat, mailing list or electronic bulletin board).

In the configuration, a history database which records the histories of the behaviors of the user should preferably be disposed. In this case, the first decision means and the second decision means decide the chances of the communications and the occurrences thereof with reference to the histories recorded in the history database, respectively. The behaviors of the users are typically the physical movements of the users and the electronic communications in the electronic space.

Besides, background information decision means for extracting the histories which match designated conditions may well be disposed In this case, the first decision means and the second decision means decide the chances of the communications and the occurrences thereof every designated condition, while the analysis means analyzes the communications every designated condition. It is also preferable to alter the threshold values of the communication occurrence decisions for the respective conditions.

The designated conditions are conditions which are selected from the group consisting of, for example, personal conditions, spatial conditions, and temporal conditions.

In the configuration, it is also allowed that position sensing means for sensing the positions of the users is utilized so as to decide the duration time period of the approach between the users, on the basis of the sensed outputs of the position sensing means, and that the communicational chance decision means and the communication occurrence decision means decide the chance of the communication and the occurrence thereof on the basis of the duration time period, respectively. Typically, when the users approach in excess of a sensible duration time period, the communicational chance decision means decides the chance of the communication. By way of example, when a record indicating the approach between the users remains, it is decided that the chance of the communication existed. Of course, a threshold value which is greater than the sensible duration time period may well be set so as to decide the chance of the communication on the basis of the approach whose duration time period is, at least, the threshold value. When the duration time period is, at least, a predetermined threshold value, the communication occurrence decision means decides the occurrence of the communication. The predetermined value is set at a time period which is sufficient for expecting that the communication occurred, but it should preferably change in accordance with various factors,

Besides, the communicational chance decision means may well decide the chance of the communication on the basis of an access to a dialog space which is built by an electronic communication system. The dialog space is a mailing list or an electronic bulletin board.

Besides, the communicational chance decision means may well decide the chance of the communication on the basis of the approach between the users as based on sensed outputs of position sensing means for sensing the positions of the users.

Besides, the communication occurrence decision means may well decide the occurrence of the communication on the basis of a dialog in a dialog space which is built by an electronic communication system.

It is also allowed to configure an organization rigidification apparatus which analyzes organization rigidification by utilizing a communication analysis.

Incidentally, this invention can be incarnated, not only as the apparatus or a system, but also as a method. Besides, it is a matter of course that part of such an invention can be configured as software. It is also natural that a software product which is used for causing a computer to execute such software is covered within the technical scope of this invention.

The above aspects and other aspects of this invention will be defined in the appended claims, and will be detailed in conjunction with embodiments below.

Now, embodiments of this invention will be described.

[Embodiment 1]

There will be described a communication analysis system 100 in Embodiment 1 of this invention. This embodiment consists in acquiring the position information items of each user by employing a position information acquisition server, and deciding the chances of the communications of the user, as well as the occurrences of the communications. This embodiment is premised on the following: The sharings of places for very short time periods (chance encounters) can be considered as the communicational chances, namely, a probability at which the communications occur, because of physical approaches in which no dialogs occur. Therefore, the probability at which the communications can occur is considered for a communicational amount, thereby to measure the amount of the communications more accurately and to analyze the rigidification of the communications of an organization

The communication analysis system 100 of this embodiment is typically incarnated by installing various programs 201 in a computer 200. The communication analysis system 100 may be configured of either a single computer or a plurality of computers. Functional blocks to be explained below are incarnated by causing the hardware resources and software resources of the computer 200 to collaborate.

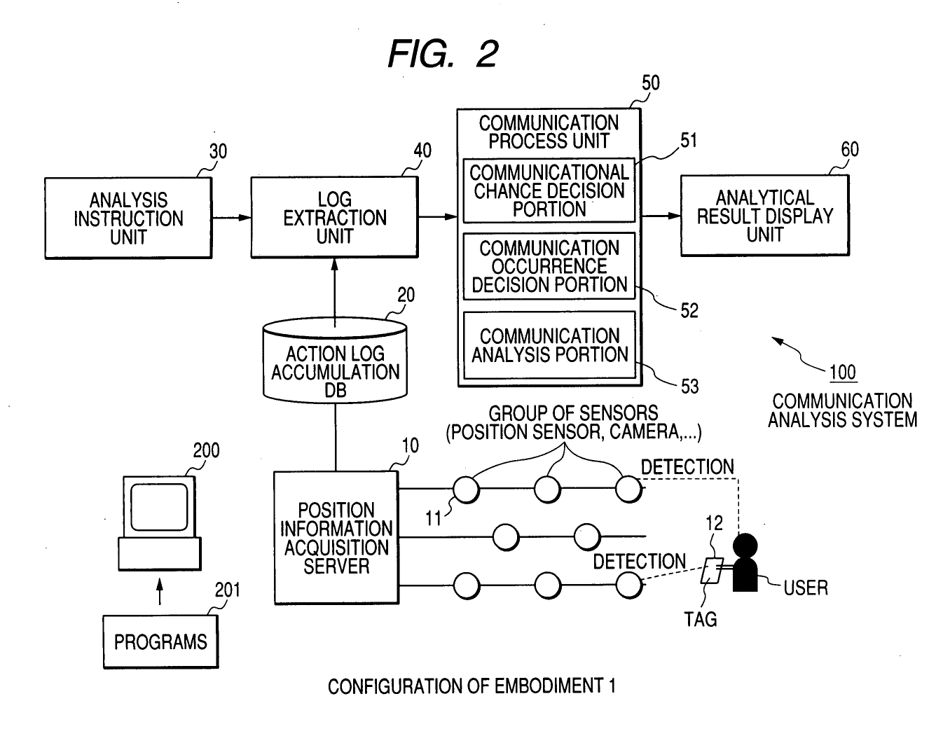

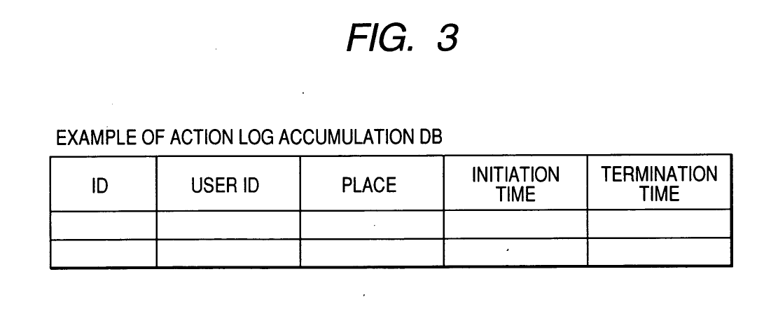

Referring to FIG. 2, the communication analysis system 100 of this embodiment is configured including the position information acquisition server 10, an action log accumulation database 20, an analysis instruction unit 30, a log extraction unit 40, a communication process unit 50, and an analytical result display unit 60. The position information action server 10 acquires the position information of the user in such a way that an RFID tag 12 held by the user is sensed by groups of sensors 11. The position information acquired by the position information acquisition server 10 is retained in the action log accumulation database 20 as an action log. The action log is as shown in FIG. 3 by way of example, and it has fields such as a record ID, a user ID, a place, an initiation time and a termination time. The communication process unit 50 is configured including a communicational chance decision portion 51, a communication occurrence decision portion 52 and a communication analysis portion 53.

The analysis instruction unit 30 inputs analysis conditions and output conditions. The analysis conditions designate the user or a group to-be-handled, temporal conditions such as a term, and the place to-be-handled. The output conditions designate output aspects such as print and display. The output aspects contain sending based on electronic mail or the like, upload to a Web page, and so forth. The log extraction unit 40 extracts the action logs (FIG. 3) in accordance with the analysis conditions, so as to derive the shared parts of the place and the time period and to generate a record. The communicational chance decision portion 51 of the communication process unit 50 decides the existence of the communicational chance between the users who have the shared parts of the place and the time period, irrespective of the duration of the shared time period. Of course, a slight time period Δt may well be set as a threshold value so as to decide the existence of the communicational chance when the shared time period is, at least, the threshold value. The communication occurrence decision portion 52 decides the existence of the communication when the shared time period is, at least, a predetermined threshold value. The communication analysis portion 53 analyzes the degree of communication occurrences in association with the communicational chances. The analysis has various aspects and will be exemplified later, but the examples are not restrictive. Essentially, any analytical aspect can be adopted as long as it indicates the degree to which the communicational chances are utilized for the occurrences of the communications. The analytical result display unit 60 displays an analytical result.

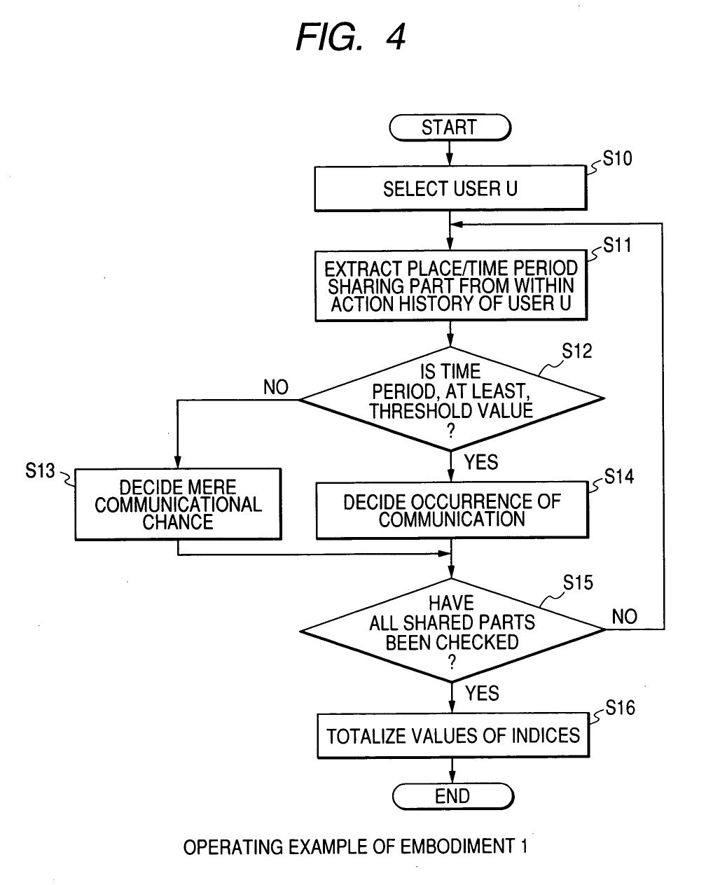

FIG. 4 shows an operating example which analyzes the communications of a predetermined user in this embodiment. Here in this embodiment, the analysis of the communicational state of the user is assisted by the number of times and time periods of the communications and the chances of the communications. It is assumed that users who existed at an identical time in an identical place on the basis of action logs in a certain organization had one time of communicational chance. A threshold value is set, and the occurrence of a dialog is estimated in accordance with the threshold value. Changes having occurred in time series are graphed, thereby to decide the degree to which the chances of the communications were effectively utilized.

Indices which can be adopted in this embodiment are as follows:

CC: Number of times which communications within a designated term occurred;

CT: Cumulation of shared time periods in the communications within the designated term;

CTA: Average of the shared time periods per communication, in the communications within the designated term;

MC: Cumulation of the number of times which identical places and identical time periods including short time periods were shamed within the designated term;

NCP: Frequency (probability) in a certain time period, at which the identical places and the identical time periods including the short time periods were shared within the designated term;

MCN: Value normalized with respect to any other user.

The details of the operating example in FIG. 4 are as stated below.

[Step S10]: A user U is selected on the basis of the designation of the analysis instruction unit 30.

[Step S11]: The shared part of a place and a time period with the action history of any other user (who can be confined in a range to-be-handled) is extracted on the basis of the action history of the user U.

[Step S12]: It is decided if the shared time period of the extracted shared part is, at least, a threshold value. When the time period is, at least, the threshold value, the routine proceeds to a step S14, and when not, the routine proceeds to a step S13.

[Step S13]: Since the shared time period is less than the threshold value, it is decided that a communication did not occur, but that merely the chance thereof existed. Here, the number of times (MC) of the communicational chances is incremented

[Step S14]: Since the shared time period is, at least, the threshold value, it is decided that the communication occurred by utilizing the chance thereof. Here, the indices CC, CT and MC are incremented.

[Step S15]: It is decided if all the shared parts of the places and the time periods with the action histories of the other users have been checked regarding the action history of the user U. When all the shared parts have been checked, the routine proceeds to a step S16, and when not, the routine returns to the step S11 so as to repeat the processing.

[Step S16]: The values of the indices CC, CT, MC, etc. are totalized, for example, every term.

The above process is applicable, not only in individual units, but also in group or project units or to the whole organization.

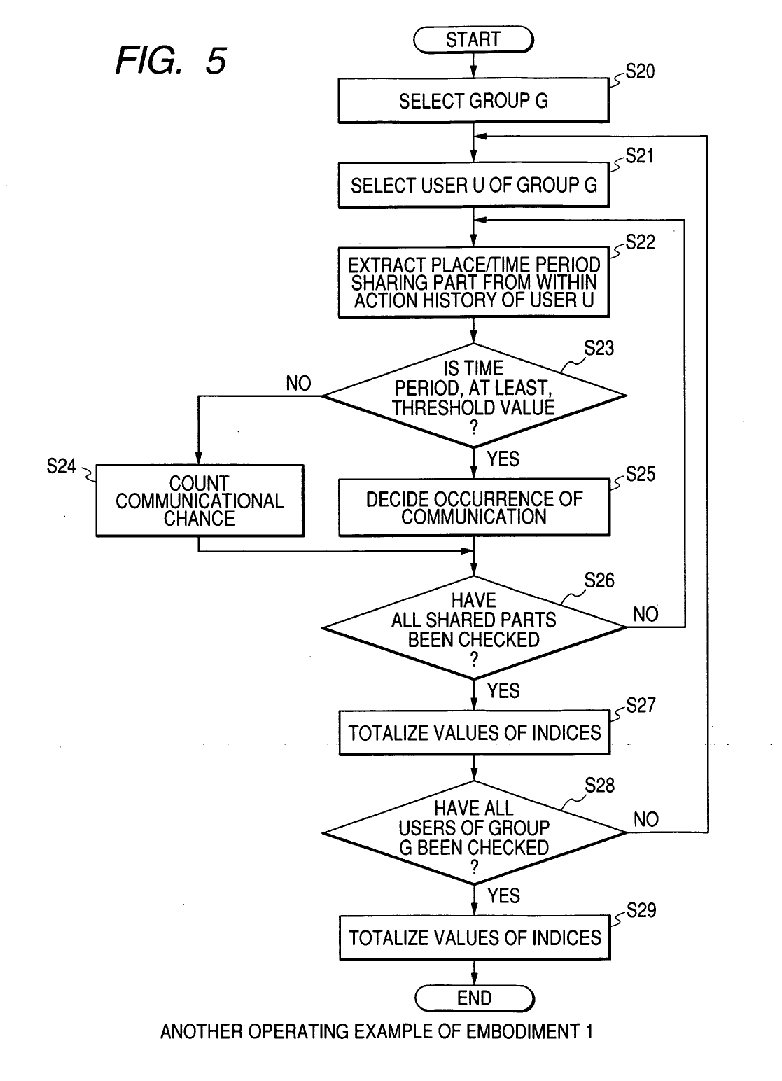

FIG. 5 shows an operating example which analyzes the communications of a group in this embodiment, and the details of the example are as stated below. Incidentally, it can be appropriately chosen if the opposite parties of the communications are within the group.

[Step S20]: A group G is selected on the basis of the designation of the analysis instruction unit 30.

[Step S21]: A user U belonging to the group G is selected.

[Step S22]: The shared part of a place and a time period with the action history of any other user (who can be confined in a range to-be-handled) is extracted on the basis of the action history of the user U.

[Step S23]: It is decided if the shared time period of the extracted shared part is, at least, a threshold value. When the time period is, at least, the threshold value, the routine proceeds to a step S25, and when not, the routine proceeds to a step S24.

[Step S24]: Since the shared time period is less than the threshold value, it is decided that a communication did not occur, but that merely the chance thereof existed. Here, the number of times (MC) of the communicational chances is incremented.

[Step S25]: Since the shared time period is, at least, the threshold value, it is decided that the communication occurred by utilizing the chance thereof. Here, the indices CC, CT and MC are incremented.

[Step S26]: It is decided if all the shared parts of the places and the time periods with the action histories of the other users have been checked regarding the action history of the user U. When all the shared parts have been checked, the routine proceeds to a step S27, and when not, the routine returns to the step S22 so as to repeat the processing.

[Step S27]: The values of the indices CC, CT, MC, etc. of the user U are totalized, for example, every term.

[Step S28]: It is decided if all the users of the group G have been checked. When all the users have been checked, the routine proceeds to a step S29, and when not, the routine returns to the step S21 so as to repeat the processing.

[Step S29]: The values of the indices CC, CT, MC, etc. of the whole group are totalized, for example, every term.

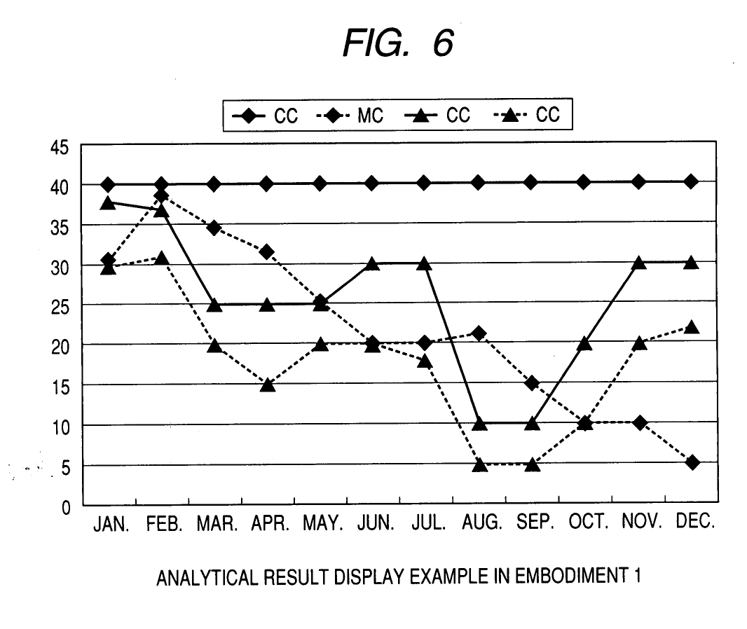

FIG. 6 shows an analytical result display example. This example is such that, on the basis of the action logs of certain users, the changes of communicational chances (MC) and communication occurrences (CC) which the users had are displayed in time series. Here, the certain two users (or groups) are respectively represented by rhombi and triangles. Besides, in each of the representations, a solid line denotes the values of the index CC, while a broken line denotes the values of the index MC. On this occasion, in the case of the rhombi, it is seen that although the communicational chances rhombic solid line) do not change, the communication occurrences (rhombic broken line) lower. On the other hand, in the case of the triangles, it is seen that the communication occurrences (triangular broken line) are often lower than in the case of the rhombi, but that in actuality, the communicational chances (triangular solid line) are also smaller in number. That is, when the proportion between the chances and the occurrences is considered, it is understood that the degree of utilization is higher (an organization has less rigidified) in the case of the triangles.

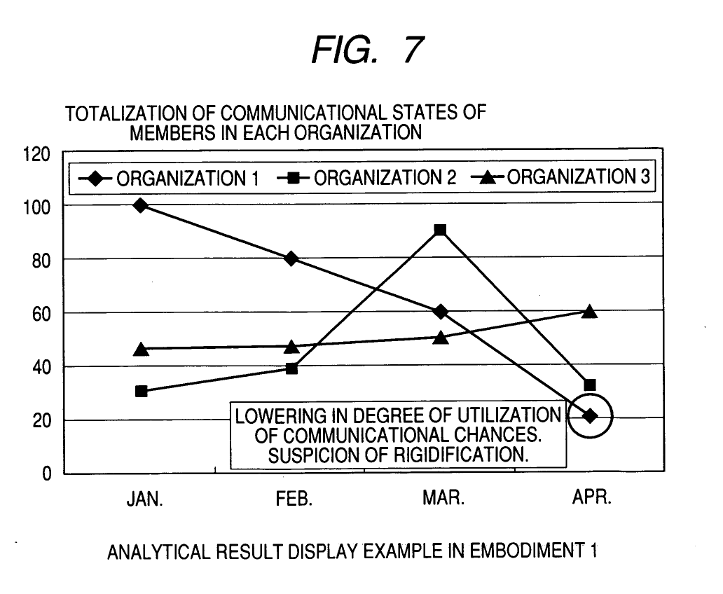

FIG. 7 shows another analytical result display example. This example is such that the ratios percentages) of communication occurrences to communicational chances are totalized and displayed for organizations 1, 2 and 3. In the organization 1, the degree of utilization of the communicational chances decreases with the lapse of time, and it is highly plausible that the organization will have rigidified.

In this embodiment, the amount of communications is corrected using a communication probability. Thus, when any organization is to be compared with another, the amounts of communications in the organizations are not simply compared, but communicational chances which are absolutely existent between the organizations or between individuals can be considered.

Besides, since the communications are extracted from the action logs of users, the process can be easily executed by managing only the action logs.

A subject for the analysis is the whole organization, a group, an individual, or the like, and it can be designated at will.

It is possible to appropriately adopt the indices such as the number of times CN of communications, the communication time period CT, and the communicational chances MC.

The communicational amounts after the corrections are calculated as CC(target)/MC(target): the probability of communication occurrences, but this is not restrictive. Any of the indices stipulated before may well be used.

[Embodiment 2]

Next, Embodiment 2 of this invention will be described. In this embodiment, at least one other axis is considered in addition to the two axes of communicational chances and communication occurrences. Information items on the additional axes (conditions) are offered by a communication background information decision unit 70.

Broadly, the following three items are considered as the communication background information items:

(1) Information on Persons

In accordance with the individual information items of users (organizations to which the users belong, administrative posts, or the likes), communicational chances and the occurrences of communications are compared between a specified individual or a specified organization or post and any other individual or any other organization or post.

The condition of the combination of the specified users, or the like is previously determined, and a comparison is made under the condition and under any other condition.

(2) Information on Places

Communications in a specified place are compared with communications in any other place. Alternatively, the condition or decision of communicational chances or communication occurrences is changed depending upon places.

(3) Information on Time

Communications in a specified time period or at a specified time are compared with communications in any other time period or at any other time. Alternatively, the condition or decision of communicational chances or communication occurrences is changed depending upon specified time periods or specified times.

One of the conditions, or the combination of at least two of the conditions can be adopted for the comparison(s). The conditions may well be reversely reckoned from a communication occurrence probability (as the condition under which the communication occurrence probability is high, and so forth).

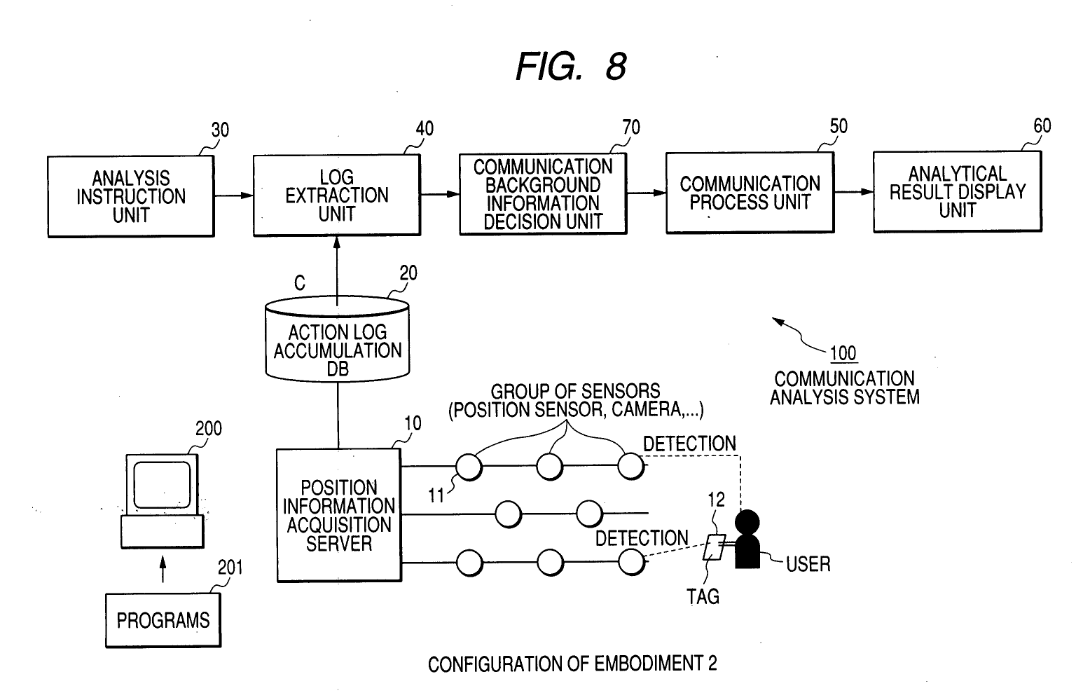

FIG. 8 shows the configuration of Embodiment 2 as a whole, and portions corresponding to those in FIG. 2 are respectively assigned corresponding reference numerals. In Embodiment 2, the communicational chances and the communication occurrences are stratified and totaled in accordance with the conditions in the communication background information decision unit 70.

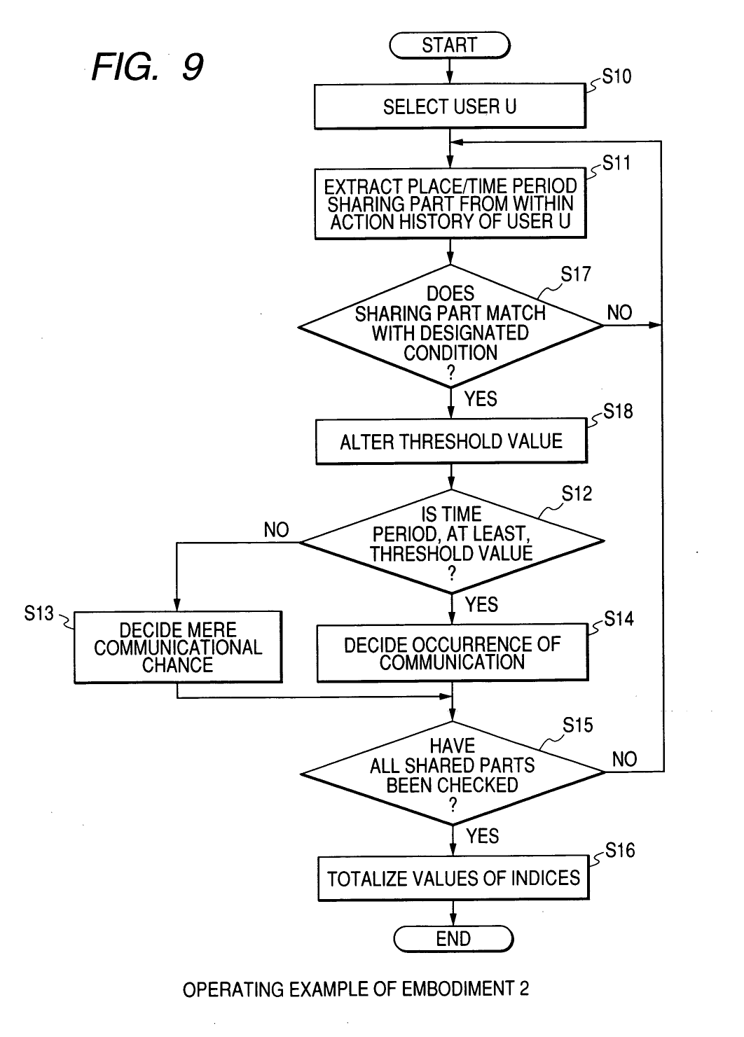

FIG. 9 shows an operating example of Embodiment 2. This example is basically the same as in FIG. 4, and steps corresponding to those in FIG. 4 are respectively assigned corresponding reference signs.

The details of the operating example in FIG. 9 are as stated below.

[Step S1O]: A user U is selected on the basis of the designation of the analysis instruction unit 30.

[Step S11]: The shared part of a place and a time period with the action history of any other user (who can be confined in a range to-be-handled) is extracted on the basis of the action history of the user U.

[Step S17]: It is discriminated if the shared part matches with a designated condition. When the shared part matches, the routine proceeds to a step S18, and when not, the routine returns to the step S11 so as to repeat the processing.

[Step S18]: In a case where the alteration of a threshold value is related to the designated condition, the threshold value is altered. Thereafter, the routine proceeds to a step S12.

[Step S12]: It is decided if the shared time period of the extracted shared part is, at least, a threshold value. When the time period is, at least, the threshold value, the routine proceeds to a step S14, and when not, the routine proceeds to a step S13.

[Step S13]: Since the shared time period is less than the threshold value, it is decided that a communication did not occur, but that merely the chance thereof existed. Here, the number of times (MC) of the communicational chances is incremented.

[Step S14]: Since the shared time period is, at least, the threshold value, it is decided that the communication occurred by utilizing the chance thereof. Here, the indices CC, CT and MC are incremented.

[step S15]: It is decided if all the shared parts of the places and the time periods with the action histories of the other users have been checked regarding the action history of the user U. When all the shared parts have been checked, the routine proceeds to a step S16, and when not, the routine returns to the step S11 so as to repeat the processing.

[Step S16]: The values of the indices CC, CT, MC, etc. are totalized, for example, every term.

As a matter of course, the above process is applicable, not only in individual units, but also in group or project units or to the whole organization.

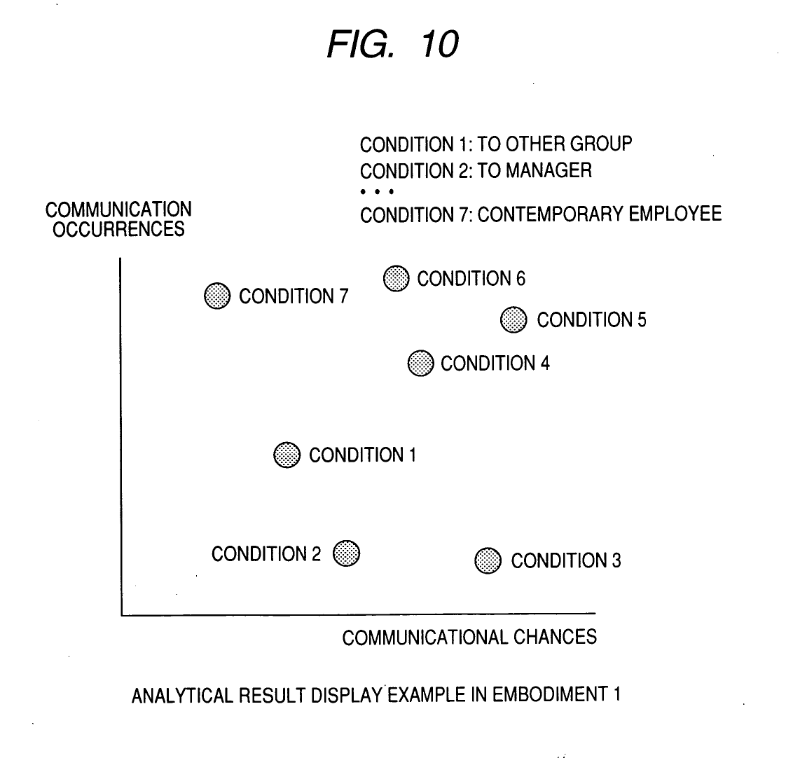

FIG. 10 shows an analytical result example. In this example, communicational chances and communication occurrences dependent upon individual conditions (personal attributes) are mapped in two dimensions, thereby to compare and analyze communication occurrence probabilities dependent upon the conditions. By the comparisons under the conditions, which parts rigidification (lowerings in the degree of utilization of the communicational chances) occurred at can be seen in more detail. In the example of FIG. 10, under the condition 3 and the condition 2, the communication occurrence probabilities are low (occurrences are of small numbers in spite of large numbers of chances), and the rigidification are considered to have occurred. Thus, it is possible to judge those parts or relations of the organization at or in which the rigidification occurred.

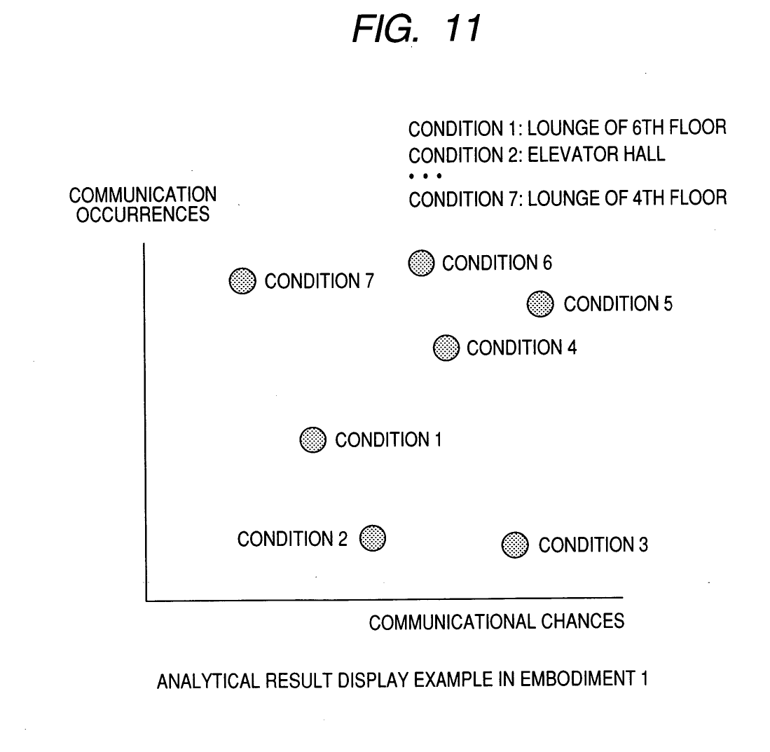

FIG. 11 shows another analytical result example. In this example, communicational chances and communication occurrences dependent upon individual conditions (spatial attributes) are mapped in two dimensions, thereby to compare and analyze communication occurrence probabilities dependent upon the conditions. According to this example, it is possible to decide places where communications occurred effectively and where not.

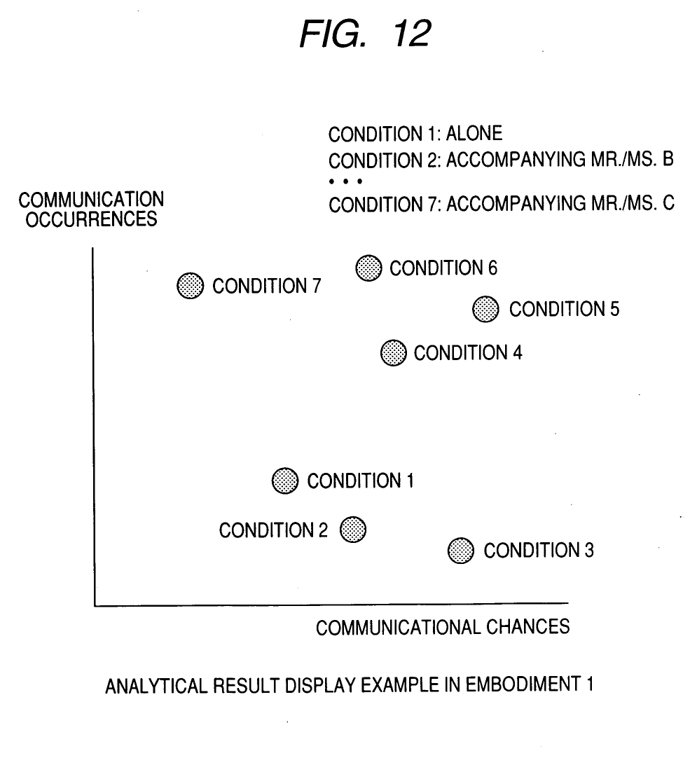

FIG. 12 shows still another analytical result example. In this example, communicational chances and communication occurrences dependent upon individual conditions (situations, namely, whom a specified user accompanied or if he/she was alone) are mapped in two dimensions, thereby to compare and analyze communication occurrence probabilities dependent upon the conditions.

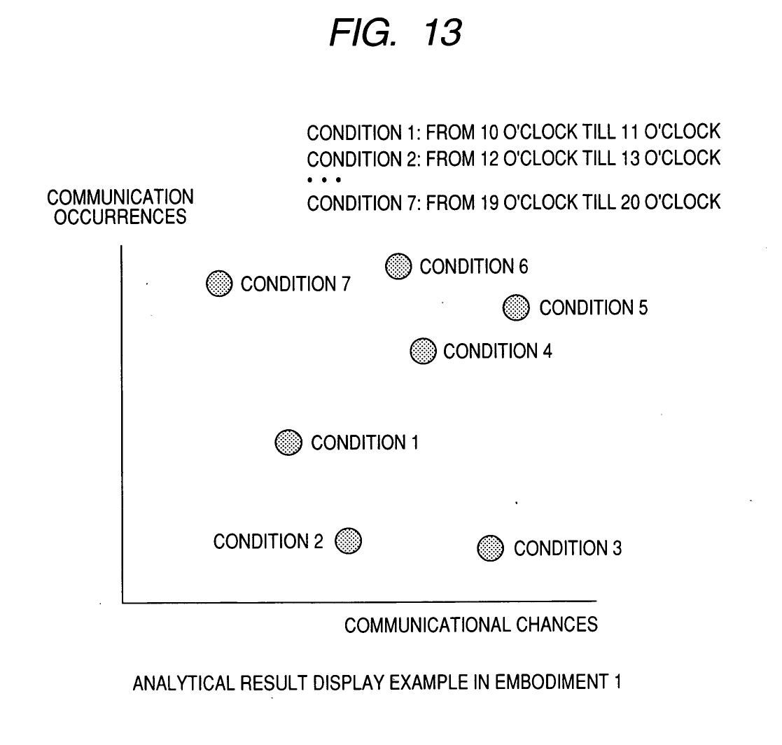

FIG. 13 shows still another analytical result example. In this example, communicational chances and communication occurrences dependent upon individual conditions (temporal attributes) are mapped in two dimensions, thereby to compare and analyze communication occurrence probabilities dependent upon the conditions.

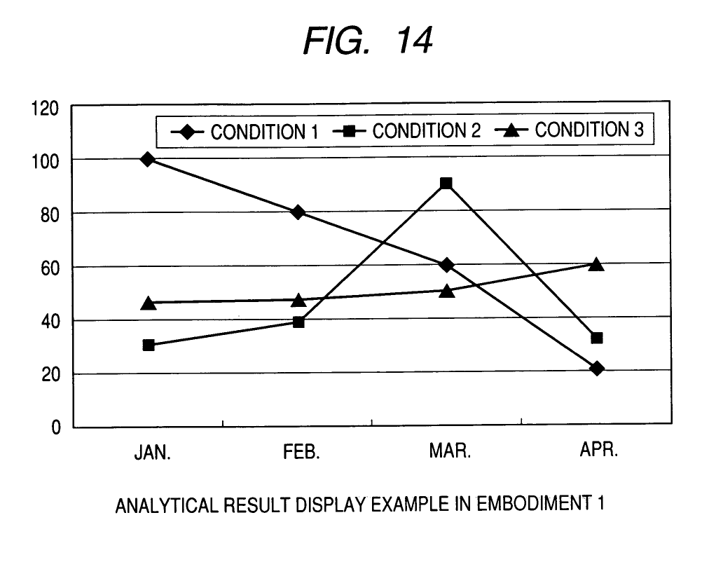

FIG. 14 shows still another analytical result example. Here, communicational chances and communication occurrences dependent upon individual conditions are mapped in time series for the respective conditions, thereby to analyze the transitions of communication occurrence probabilities dependent upon the conditions.

In this manner, the various conditions are taken into consideration in relation to the chances and occurrences of the communications, so as to stratify the chances and occurrences, whereby the various situations concerning the communications can be exactly judged.

[Embodiment 3]

Next, Embodiment 3 of this invention will be described. In the embodiment 3, communications in an electronic space (electronic bulletin boards, mailing lists and Web accesses) are considered in addition, to communications in a physical space.

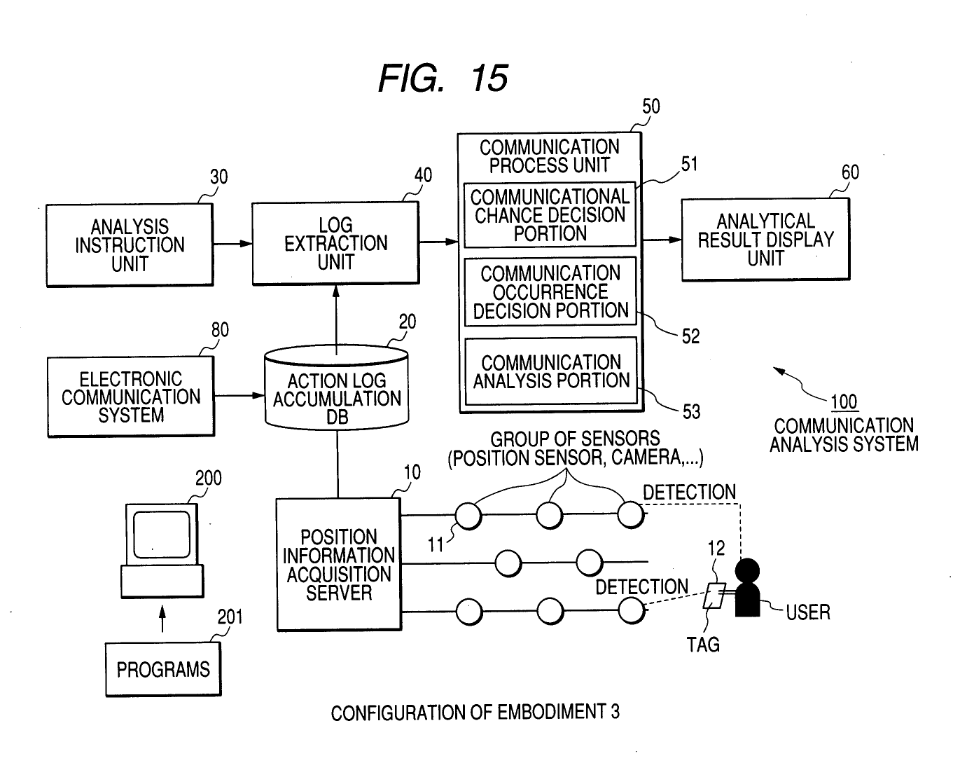

FIG. 15 shows the configuration of this embodiment as a whole. In the configuration, portions corresponding to those in FIG. 2 are respectively assigned corresponding reference numerals.

In this example, an electronic communication system 80 is disposed so as to make electronic communications possible. Here in this example, the communicational chance decision portion 51 decides the approach between users based on position information, as the chance of a communication, and the communication occurrence decision portion 62 decides the electronic communication as the occurrence of the communication. The electronic communication may be either a unidirectional communication such as electronic mail or a bidirectional one such as instant message. This example is premised on a model in which the electronic communication is performed with a momentum being the approach in the physical space. Since such a premise sometimes fails to match an actual situation, the model should preferably be adapted to circumstances.

Alternatively, an approach for, at least, a predetermined time period may well be decided as the occurrence of a communication by deciding an electronic communication as the chance of the communication.

The behavior (for example, browsing) of a predetermined type of electronic communication may well be decided as the chance of a communication, so as to decide the behavior (For example, contribution) of any other predetermined type as the occurrence of the communication.

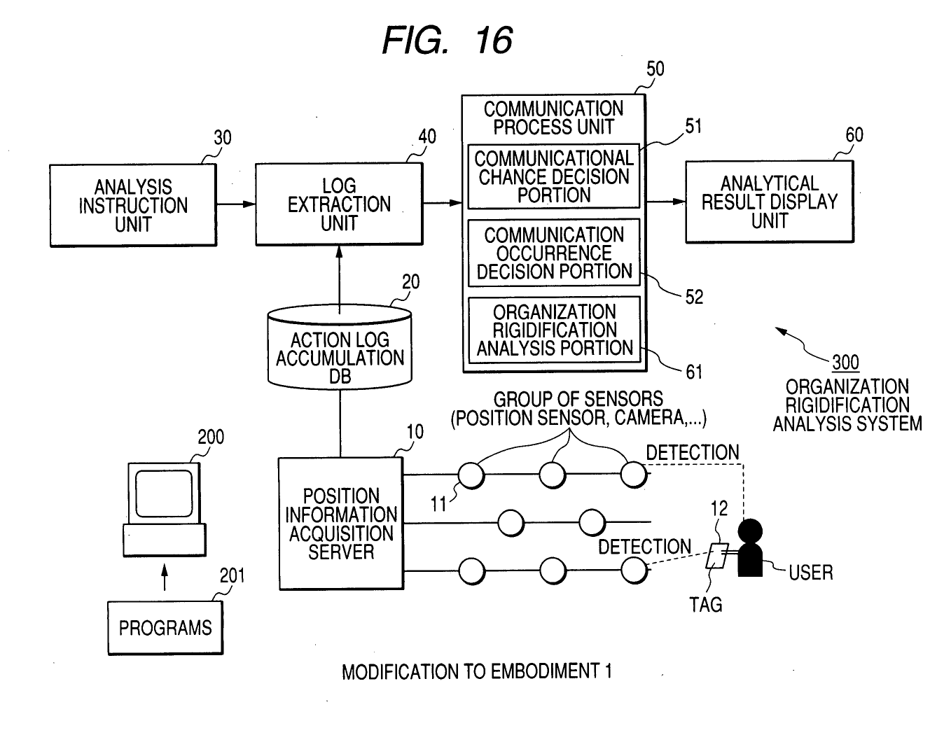

Incidentally, this invention is not restricted to the above embodiments, but it can be variously altered within a scope not departing from the purport of the invention. By way of example, this invention can also be configured as an organization rigidification analysis system which calculates the indices of the rigidification of an organization on the basis of the analytical result of communications. FIG. 16 shows an example in which the organization rigidification analysis system 300 is configured by utilizing the configuration of Embodiment 1. In FIG. 16, portions corresponding to those in FIG. 2 are respectively assigned corresponding reference numerals. In this example, an organization rigidification analysis portion 61 decides the rigidification of the organization on the basis of the decided results of the communicational chance decision portion 51 and communication occurrence decision portion 52 of the communication process unit 50. In a case, for example, where the frequency of communication occurrences is low relative to the frequency of communicational chances, it is decided that the possibility of the rigidification of the organization will be high The rigidification of the organization may well be decided on the basis of the temporal changes of the ratio between the frequency of communicational chances and the frequency of communication occurrences. Further, the rigidification of the organization can be decided by utilizing the decided results of communicational chances and communication occurrences in accordance with any of various guides. The decided result of the rigidification of the organization is displayed by, for example, the decided result display unit 60. In this case, the communication analysis portion 53 in Embodiment 1 may well be further disposed whereby the decided result display unit 60 displays the organization rigidification analysis result together with the communication analysis result. The organization rigidification analysis result may well be notified to a predetermined managerial officer or the like by electronic mail or the like. It is a matter of course that an organization rigidification analysis system 300 may well be configured by utilizing the configuration of the communication analysis system of Embodiment 2 or Embodiment 3, not the configuration of Embodiment 1.

The entire disclosure of Japanese Patent Application No. 2005-284839 filed on Sep. 29, 2005 including specification, claims, drawings and abstract is incorporated herein by reference in its entirety.

1. A communication analysis apparatus comprising:
first decision means for deciding a chance of a communication between users;
second decision means for deciding an occurrence of the communication between the users; and
analysis means for analyzing the occurrences of the communications decided by the second decision means, in association with the communicational chances decided by the first decision means.

2. A communication analysis apparatus as defined in claim 1, further comprising:
a history database which records histories of behaviors of the users,
wherein the first decision means and the second decision means decide the chances of the communications and the occurrences of the communications with reference to the histories recorded in the history database, respectively.

3. A communication analysis apparatus as defined in claim 2, further comprising:
background information decision means for extracting histories which match designated conditions is comprised,
wherein the first decision means and the second decision means decide the chances of the communications and the occurrences of the communications every designated condition, respectively, while the analysis means analyzes the communications every designated condition.

4. A communication analysis apparatus as defined in claim 3, wherein the designated condition includes at least one of a personal condition, a spatial condition and a temporal condition.

5. A communication analysis apparatus as defined in claim 1, further comprising:
position sensing means for sensing positions of the users,
wherein a duration time period for which the users approach is decided on the basis of sensed outputs of the position sensing means, and the first decision means and the second decision means decide the chance of the communication and the occurrence of the communication on the basis of the duration time period, respectively.

6. A communication analysis apparatus as defined in claim 5, wherein the first decision means decides the chance of the communication when the users approach is in excess of a sensible duration time period.

7. A communication analysis apparatus as defined in claim 5, wherein the second decision means decides the occurrence of the communication when the duration time period is, at least, a predetermined threshold value.

8. A communication analysis apparatus as defined in claim 1, wherein the first decision means decides the chance of the communication on the basis of an access to a dialog space which is built by an electronic communication system.

9. A communication analysis apparatus as defined in claim 1, farther comprising:
position sensing mean for sensing positions of the users,
wherein the first decision means decides the chance of the communication on the basis of the approach between the users as based on sensed outputs of the position sensing means.

10. A communication analysis apparatus as defined in claim 1, wherein the second decision means decides the occurrence of the communication on the basis of a dialog in a dialog space which is built by an electronic communication system.

11. A communication analysis method comprising the steps of:
(a) deciding a chance of a communication between users;
(b) deciding an occurrence of the communication between the users; and
(c) analyzing the occurrences of the communications decided by the step (b), in association with the communicational chances decided by the step (a).

12. A storage medium readable by a computer, the storage medium storing a program of instructions executable by the computer to perform a function for communication analysis, the function comprising the steps of:
(a) deciding a chance of a communication between users;
(b) deciding an occurrence of the communication between the users; and
(c) analyzing the occurrences of the communications decided by the step (b), in association with the communicational chances decided by the step (a).

13. An organization rigidification analysis apparatus comprising:
first decision means for deciding a chance of a communication between users;
second decision means for deciding an occurrence of the communication between the users; and
analysis means for analytically revealing rigidification of an organization on the basis of the occurrences of the communications decided by the second decision means and the communicational chances decided by the first decision means.

14. An organization rigidification analysis method comnprising the steps of:
(a) deciding a chance of a communication between users;
(b) deciding an occurrence of the communication between the users; and
(c) analytically revealing rigidification of an organization on the basis of the occurrences of the communications decided by the step (b) and the communicational chances decided by the step (a).

15. A storage medium readable by a computer, the storage medium storing a program of instructions executable by the computer to perform a function for organization rigidification analysis, the function comprising the steps of:
(a) deciding a chance of a communication between users;
(b) deciding an occurrence of the communication between the users; and
(c) analytically revealing rigidification of an organization on the basis of the occurrences of the communications decided by the step (b) and the communicational chances decided by the step (a).
